(19) United States
(12) Patent Application Publication
(10) Pub. No.: US 2012/0023548 A1
(43) Pub. Date: Jan. 26, 2012

(54) APPARATUS, AND AN ASSOCIATED METHOD, FOR IMPLEMENTING A PARENTAL CONTROL FEATURE AT A WIRELESS DEVICE

(75) Inventors: NICHOLAS PATRICK ALFANO, STRATFORD-UPON-AVON (GB); SURESH CHITTURI, PLANO, TX (US); MICHAEL RAO, OTTAWA (CA); JANELE BULLER, KITCHENER (CA); VIKRAM RATTAN KEWALRAMANI, WATERLOO (CA); THANE EISENER, KANATA (CA); SHILADITYA SIRCAR, OTTAWA (CA); JAMES PAUL WARDEN, FORT WORTH, TX (US); AXEL DENIS FERRAZZINI, BRUSSELS (BE); SALIM HAYDER OMAR, WATERLOO (CA)

(73) Assignee: RESEARCH IN MOTION LIMTED, WATERLOO (CA)

(21) Appl. No.: 12/843,530

(22) Filed: Jul. 26, 2010

(51) Int. Cl. G06F 21/00; G06F 15/16

(52) U.S. Cl. 726/2; 709/206

(57) ABSTRACT

An apparatus, and an associated method, facilitates implementation of a parental control feature at a mobile station. A parental authority selects a parental control feature to be implemented at the mobile station and by way of a user interface at a computer workstation or a master mobile station. Detection is made of the selection, and a control signal is generated that includes identification of the selection. The control signal is sent to the affected mobile station. Once received at the mobile station, the control signal is detected, its contents ascertained, and the parental control feature is implemented at the mobile station.

The present disclosure relates generally to a manner by which to operate a wireless device in conformity with a selected parental control feature. More particularly, the present disclosure relates to an apparatus, and an associated method, by which to provide for remote selection, such as by a parent or one with parental authority, of the parental control feature and to provide for subsequent implementation of the selected parental control feature at the wireless device. Once implemented at the wireless device, the wireless device is caused to be operated in conformity with the selected parental control feature.

Supervisory control by a parent, guardian, or other parental authority, is exercised over a child's use of the wireless device to control operability of any of various aspects of the wireless device and to provide the parental authority with information related to the child's use of the wireless device.

### BACKGROUND

Cellular mobile phones and other analogous wireless devices are used by many. While early-generation wireless devices used in cellular communication systems were used primarily for voice communications, successor-generation devices are increasingly capable of providing data-intensive services. Such wireless devices are now regularly used, e.g., to send and to receive documents of significant file sizes and to send and to receive data messages, such as push messages, as well as also to initiate and to terminate voice calls.

Concomitant with the increase in the functionality of such wireless devices has been a corresponding decrease in the costs associated with the use of such communication services. And, as a result of both increasing functionality and decreasing costs, increased numbers of users own, or are provided with, wireless devices through which to communicate pursuant to such communication services. Wireless devices are used by business, and other enterprise, personnel to effectuate enterprise communication services and also by others to effectuate personal communication services. In a family, for instance, sometimes, parents and children all have their own wireless devices to facilitate communications between the parents and the children, as well as with others. Various service providers provide family service plans that, for instance, have reduced charges for communications between family members.

In such arrangements, various schemes have been developed and made available by which to facilitate sharing of information between the familial wireless devices. For instance, a Unite!™ application is available and sometimes used. This application provides for familial, and other, groups of users to exert control over and to monitor specifically-configured, wireless devices. Users of such devices configured in such a group are able to add, update, or delete other users as well as to monitor and to restrict device activities such as SMS (Short Message Service) text messaging, MMS (Multimedia Service) messaging, internet browsing, phone usage, application downloads, and attachment viewing. Further developments related to the application pertain to setting or changing parameters on wireless devices that are registered at a familial, or other group, server. Additionally, use of a wireless device of a designated administrator is enabled remotely to set or reset parameters of other wireless devices of the group. The wireless device of the administrator is further provided with the capability to override the settings of other wireless devices and to carry out actions in a dynamic manner, during use of the other wireless devices.

While existing schemes provide for various control functions over wireless devices configured in a familial, or other group, arrangement, these existing schemes do not fully address concerns that those having parental authority and responsibility have regarding childrens' use of wireless devices. In any of various services that such wireless devices are capable of performing, the parental authority might well want to limit, or otherwise constrain, a child's unsupervised ability to participate in the communication services. Dynamic filter engines and parental filter tools are available for conventional computer work stations that are connected to the internet, but unique challenges are associated with parental control over childrens' use of wireless devices.

It is in light of this background information related to wireless devices that the significant improvements of the present invention have evolved.

### BRIEF DESCRIPTION OF THE DRAWINGS

FIG. 1 illustrates a functional block diagram of a communication system in which an embodiment of the present disclosure is operable.

FIG. 2 illustrates a message sequence diagram representative of the exemplary operation of the communication system shown in FIG. 1.

FIG. 3 illustrates a method flow diagram representative of the method of operation of an embodiment of the present disclosure.

### DETAILED DESCRIPTION

The present disclosure, accordingly, advantageously provides an apparatus, and an associated method, by which to operate a wireless device in conformity with a selected parental control feature.

Through operation of an embodiment of the present disclosure, a manner is provided by which to provide for remote selection, such as by a parent or one with parental authority, of the parental control feature and to provide for subsequent implementation of the parental control feature at the wireless device. Once implemented thereat, the wireless device is caused to be operated in conformity with the selected parental control feature.

In another aspect of the present disclosure, the supervisory control is granted to a parent, guardian, or another having parental authority, over a child's use of the wireless device. When supervisory control is granted, person to whom the control is granted assumes the role of an administrator or systems administrator. The supervisory control is exerted to control the operability of any of various aspects of a child's wireless device and to impose any of various constraints upon the operability of the child's wireless device and to provide for parental monitoring of communication-service operation of the child's wireless device.

In another aspect of the present disclosure, a home-positioned familial or other group, processing entity, such as a home computer, workstation, or server, is configured to select detection by a parental authority of parental control features that are to be implemented at a child's wireless device. Selection is made, for example, by the parental authority who assumes an administrative role and who enters the selection at the processing entity or at a device in communication connectivity therewith by way of an administrator console.

In another aspect of the present disclosure, responsive to the selection made by the parental authority, a control signal is generated at the familial or group processing entity for communication to the affected wireless device. That is to say, a control signal is generated that forms a command to command the child's wireless device to implement the parental control selected by the parental authority. The control signal includes, amongst other things, an identification of the wireless device at which the selected parental control is to be implemented as well as identification of the selected parental control.

In another aspect of the present disclosure, rather than use of an administrator console of a home-positioned familial or group processing entity, detection of selection is made at an administrator console of a wireless device used by the parental authority. That is to say, the processing entity is mobile-positioned. The parental authority, for instance, makes selection of the parental control feature that is to be implemented by way of a user interface of the wireless device used by the parental authority. The control signal, in this implementation, is generated at the wireless device of the parental authority. The control signal at least identifies the affected wireless device and the selected parental control. Once generated, the control signal is sent by the wireless device of the parental authority to the wireless device of the child at which the parental control feature is to be implemented.

In another aspect of the present disclosure, a detector is positioned at a child's wireless device to detect reception at the wireless device of a control signal that commands implementation of a parental control feature at the wireless device. The control signal includes identification of the one or more parental control features that the wireless device of the child is commanded to implement.

In another aspect of the present disclosure, once detection is made of the reception at the child's wireless device of the control signal, the contents of the control signal are ascertained to determine which parental control feature is to be implemented at the wireless device. An implementer configured at the child's wireless device operates to initiate implementation of the parental control feature identified in the control signal. Once the parental control feature is implemented, the child's wireless device is caused to operate in conformity with the parental control feature. Constraints or other limits placed on the operation of the wireless device constrain the child's use of the wireless device. And, if the parental control feature requires that the wireless device provide the parental authority with information related to the child's use of the wireless device, the child's wireless device is caused to operate in a manner to provide the information to the parental authority.

In another aspect of the present disclosure, any of various parental control features are caused to be implemented at the child's wireless device. For example, in one implementation, the parental control feature locks up applications, such as games, to prevent their use during school hours, or other selected time periods. The parental control feature also selectably causes locking of camera usage of a camera embodied at the child's wireless device. In another implementation, the parental control feature comprises collection and logging of voice call times, duration, and calls placed by the child by way of the wireless device. In another implementation, the parental control feature comprises collection and returning to the parental authority all text messages, either or both sent messages and received messages. In another implementation, the parental control feature controls the use of the wireless device based on the geographical location of the child. For instance, the parental control feature prohibits voice calls from being placed while the child is at school. In another implementation, the parental control feature comprises a limitation on use of the wireless device based upon the time of day, e.g., the child's wireless device is prohibited from receiving inbound calls during school hours. In another implementation, the parental control feature comprises prohibition of incoming calls from prohibited calling numbers. In another implementation, the parental control feature causes redirection of, or forwarding of, incoming calls from specific calling numbers to the phone of the parental authority. In another implementation, the child's wireless device also includes location capabilities, such as global positioning capability, site triangulation, etc. And, the parental control feature defines the geographic boundaries prohibiting, or permitting, wireless-device functionality when within, or beyond selected boundaries. And, in one implementation, the parental control feature comprises control over the child's wireless-device browser capability. In another implementation, the parental control feature controls which applications are permitted to be downloaded to the child's wireless device by way of an open Internet connection. Games are, e.g., prohibited from being downloaded, or the games are restricted based on their origin, e.g., website address, or content, e.g., age restricted. And, in another implementation, the parental control feature prevents deletion, or reconfiguration, of installed applications at the wireless device. A child is prevented, e.g., from inadvertently, or otherwise, removing or altering applications that benefit the child or permit parental authority or monitoring from being exercised.

In these and other aspects, therefore, an apparatus, and an associated method, for facilitating affectuation of a wireless-device parental control feature. A selection detector is configured to detect selection of at least a first wireless-device parental control feature. A control signal generator is adapted to receive an indication of the selection detected by the selection detector. The control signal generator is configured to generate a wireless-device control signal. The wireless-device control signal is of values that, when received, cause the operation of the wireless device in conformity with the wireless-device parental control feature.

In these and further aspects, further apparatus and methodology is provided for facilitating affectuation of a parental control feature at a wireless device. A control signal detector is configured to detect reception at the wireless device of a control signal of values that are representative of at least a first wireless-device parental control feature. And, a parental control feature implementer is configured to initiate implementation of the wireless-device parental control feature.

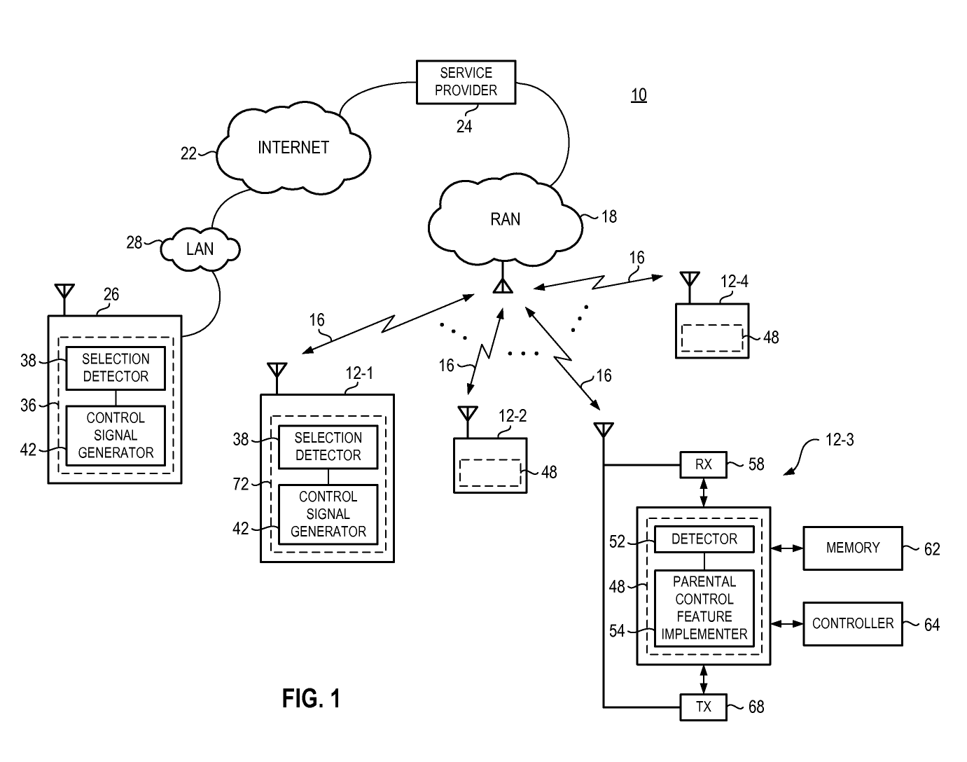

Turning first, therefore, to FIG. 1, a communication system, shown generally at 10, provides for communications with mobile stations, of which the mobile stations 12 are representative. Here, for mobile stations, mobile stations 12-1, 12-2, 12-3, and 12-4, are mobile stations of a familial group. That is to say, the mobile stations are operated by members of the family and, here, one or more of the mobile stations is used by a child, that is, a family member over whom parental control is to be exerted. More generally, one, or more, of the mobile stations comprises a controlled mobile station, controlled with respect to a parental control feature, by a controlling entity. While in the exemplary implementation, the mobile stations 12 comprise mobile stations operable in a cellular communications system, more generally, the mobile stations 12 are representative of any of various types of wireless devices operable in radio communication systems.

Communications with, by, and between, the mobile stations are effectuated by way of a radio air interface, here represented by the arrows 16. The radio air interface is defined between the mobile stations and a radio access network (RAN) 18, which is, in turn, coupled to a data network, here the internet 22, by way of a service provider entity 24. The service provider entity 24 fractions, amongst other things, to transport data through, and between, the networks 18 and 22 and to manage the RAN 18.

Communication entities are placed in communication connectivity with the data network, here including a familial, or other, group processing entity 26, here an Internet-connected, home computer. The family processing entity is here connected to the data network 22 by way of a local (LAN) network 28 of communication connectivity with the network 22. The service provider provides for routing of data that is communicated during effectuation of a communication service by, or with, a mobile station 12, including data communicated pursuant to operation of an embodiment of the present disclosure.

The family processing entity is representative of any of various processing devices through which certain data communicated pursuant to effectuation of a communication service is routed to or from a mobile station 12 of the familial group. While existing applications, as noted previously, provide for various sharing of information of the familial-group mobile stations and other advantageous features, existing applications do not fully provide for parental control that a parent or other person of parental authority might want to maintain over a controlled mobile station, such as a mobile station used by a child. Pursuant to an embodiment of the present disclosure, the communications system 10 includes a new apparatus, shown generally at 36, that provides for selected parental control features to be implemented at a mobile station and subsequent operation of the affected mobile station or mobile stations in conformity with the parental control feature. By such operation, the parental authority is able better to ensure that a child having a mobile station is able to operate the mobile station in accordance with the parental authority's desires as defined by the parental control features that the parental authority, through interaction with the apparatus 36, causes to be implemented at the child's mobile station. The parental authority, acting as an administrator or system administrator interacts with an administrator console formed at the familial processing entity 26 to interact with, and cause operation of, the apparatus 36.

The apparatus 36 is implementable in any desired manner, including software executable by processing circuitry, hardware entities, and combinations thereof. And, while the apparatus 36 in the exemplary implementation shown in FIG. 1 is embodied at the familial processing entity 26, functionalities of the apparatus are, in other implementations, located elsewhere, or distributed across more than one entity.

The apparatus 36 includes a selection detector 38 and a control signal generator 42. The selection detector operates to detect selection by a parental authority of a parental control feature with which the affected mobile station is to conform. Selection is made by the parental authority. The parental authority enters the information by way of a user interface of the workstation that, in turn, conveys the entered information to the family server 26 whereat the selection detector 38 detects the parental-authority-entered, parental-control-feature selection. One or more parental control features may be selected by the parental authority for implementation at a selected mobile station, or more than one mobile station. And, separate parental control features are also selectable for different mobile stations of the familial group. That is to say, the parental authority might select a first set of parental control features to be implemented at the mobile station of a first child and a second set of parental control features at a mobile station used by a second child. These selections entered by the parental authority, indexed together with the appropriate mobile station, are conveyed to the apparatus 36 at the family processing entity 26 and detected by the selection detector 38. Selection of the parental authority is ascertained, and indications of the selection are provided to the control signal generator 42. The control signal generator operates to generate a control signal that includes indications of the parental control feature or features selected by the parental authority to be implemented at the affected mobile station or mobile stations. The control signal generated by the control signal generator identifies both the affected mobile station and the identification of the parental control feature that is to be implemented.

Once generated, the control signal is routed through the data network 22, to the server 24, then forwarded through the radio access network 18 and sent by way of the radio air interface 16 for delivery to a mobile station 12. The control signal acts as a command, which commands the mobile station to operate in conformity with the identified parental control feature.

The childs' mobile stations 12, here mobile stations 12-2, 12-3, and 12-4, include apparatus 48 of an embodiment of the present disclosure. The apparatus 48 also is functionally represented, implementable in any desired manner, including software executable by processing circuitry, hardware entities, and combinations thereof.

The apparatus 48 includes a control signal detector 52 and a parental control feature implementer 54. The detector 52 detects reception by the receive part 58 of the mobile station 12. The contents of the detected control signal are ascertained, and indications of the parental control feature or features contained in the control signal are provided to the parental control feature implementer 54. The implementer 54 functions to initiate implementation of each parental control feature identified in the control signal detected by the detector. Depending upon on the parental control feature, the implementer 54 accesses a mobile-station memory 62, a mobile-station controller 64, and/or a transmit part 68 of the mobile station. Through such interaction, the parental control feature is caused to be implemented. If constraints are placed upon communication-service functionalities of the mobile station, the parental control feature implementer initiates the imposition of the constraints. And, if the control feature mandates parental monitoring or forwarding of communication messages, the implementer 54, through its interaction with the memory, controller, and transmit part provide for the affectuation of the monitoring or forwarding required to conform to the parental control feature.

FIG. 1 further illustrates an alternate implementation of an embodiment of the present disclosure. Here, the mobile station 12-1 forms a master mobile station, operated by the parental authority. In this implementation, the master mobile station includes the apparatus, here represented by 72, which contains the selection detector 38 and control signal generator 42, analogous to the functionalities of the corresponding elements of the apparatus 36 embodied at the family processing entity 26. When the apparatus 72 is embodied at a master mobile station, the familial group need not be managed by a home-positioned family processing entity. And, instead, the parental authority makes selection of the parental control features that are to be implemented at a controlled mobile station, here a child's mobile station, such as the mobile stations 12-2, 12-3, and 12-4, by way of an administrator console, formed of the user interface of the mobile station 12-1. The selection detector of the apparatus 72 detects the entry of the selected parental control feature along with, when entered, the identity of the mobile station at which the parental control feature is to be implemented. Detected selections are provided to the control signal generator 42 of the apparatus 72, and the control signal generator generates a control signal that is communicated to the affected mobile station so that the selected parental control feature can be implemented at the affected mobile station.

Any of various parental control features are implementable pursuant to operation of an embodiment of the present disclosure. If the parental authority chooses the parental authority control operation of a controlled mobile station, e.g., to lock applications, such as games, during school hours, lock camera usage, limit use of the mobile station, or an application thereat, based upon the time of day, block certain other calling or called parties from communicating with the child by way of the mobile station, limit operability or the functionality of the mobile station depending upon the geographic positioning of the mobile station, control browser usage at the mobile station, collect communication-service information relating to affectuation of a communication service at the mobile station, and/or forward calls placed to the mobile station. Any of various other controls can be implemented. For instance, the parental authority, in one implementation, limits the applications that are permitted to be downloaded to the wireless device by way of the Internet connection. Limitation is placed on the downloading based upon the source, e.g., web address, of the application or the content of the application. For example, a game is prohibited from being downloaded if sourced from a prohibited website or is of age-restricted or content-restricted content. And, the parental authority can also restrict changes to installed applications at the child's wireless device.

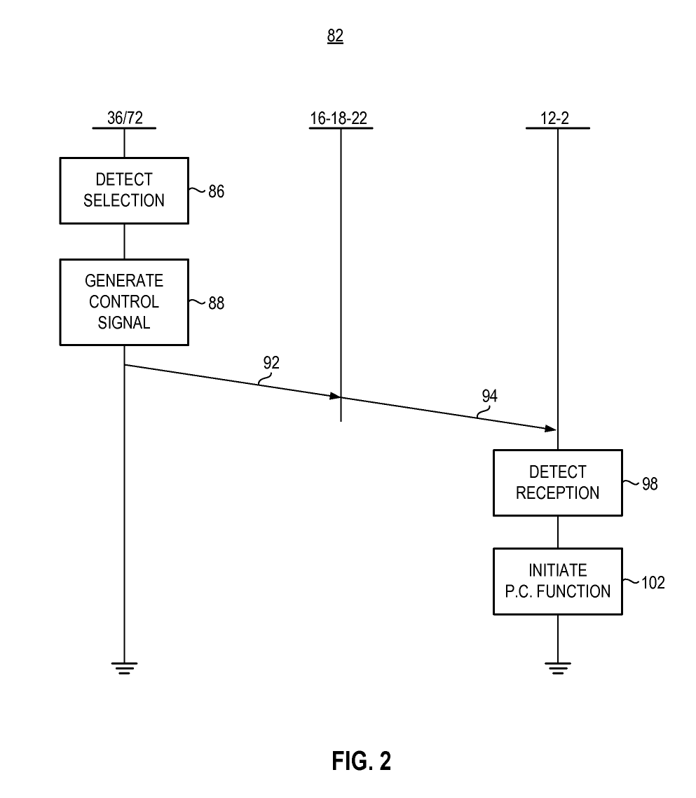

FIG. 2 illustrates a representation, shown at 82, representative of exemplary operation of the communication system shown in FIG. 1 pursuant to an embodiment of the present disclosure. Pursuant to operation, a parental authority causes selected parental control features to be implemented at a controlled, wireless device, e.g., a mobile station used by a child in a familial group of mobile stations.

A parental authority initiates operation by making selection of a parental control feature for a controlled mobile station. Selection is made, e.g., by way of a computer workstation or a mobile station having appropriate user interface capabilities to provide for the parental authority's selection. Selection is detected, indicated by the block 86, at an apparatus 36 or 72, wheresoever implemented. And, subsequent to detection, a control signal is generated, indicated by the block 88. The control signal identifies the mobile station at which the parental control feature is to be implemented as well as the identification of the selected parental control feature or features. Once generated, the control signal is routed, indicated by the arrows 92 and 94, through an appropriate route in the packet data network 22, radio access network 18, and channels defined upon the radio air interface 16, to the appropriate mobile station, here exemplified by the mobile station 12-2.

Once received at the mobile station, its reception is detected, indicated by the block 98. And, the contents of the detected control signal are ascertained. And, implementation of the parental control features is initiated, indicated by the block 102.

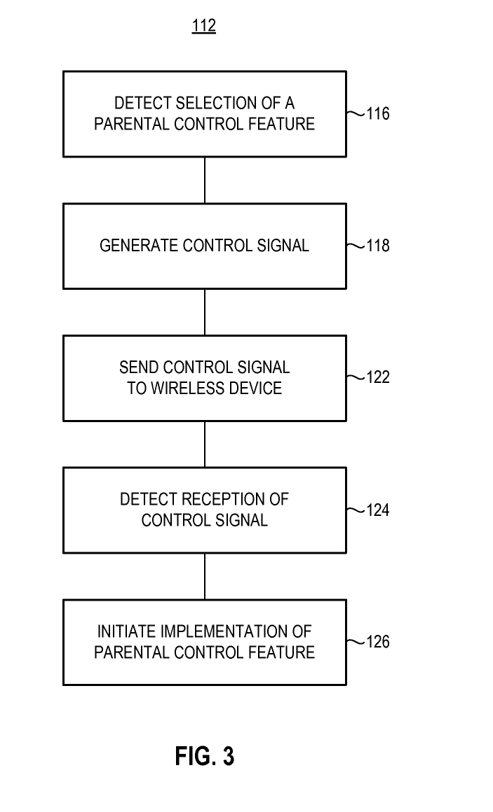

FIG. 3 illustrates a method flow diagram, shown generally at 112, representative of the method of operation of an embodiment of the present disclosure. The method facilitates effectuation of a parental control feature at a wireless device.

First, and as indicated by the block 116, subsequent to selection by a parental authority of a parental control feature to be implemented at a wireless device, detection is made, indicated by the block 116, of the selected wireless-device parental control feature. Then, as indicated by the block 118, a control signal is generated that is of values to cause wireless-device operation in conformity with the selected parental control feature.

The control signal is sent, indicated by the block 122 and received at a wireless device.

At the wireless device, and as indicated by the block 124, the control signal is detected. And, as indicated by the block 126, implementation of the parental control feature at the wireless device is initiated.

A parental authority is thereby able easily to select a parental control feature to be implemented at a wireless device and easily also able to cause its implementation at the wireless device used by a child.

The previous descriptions are of preferred examples for implementing the invention, and the scope of the invention should not necessarily be limited by this description. The scope of the present invention is defined by the following claims.

What is claimed is:

1. An apparatus for facilitating effectuation of a wireless-device parental control feature, said apparatus comprising:
a selection detector configured to detect selection of at least a first wireless-device parental control feature; and
a control signal generator adapted to receive an indication of the selection detected by said selection detector, said control signal generator configured to generate a wireless-device control signal, the wireless-device control signal of values that, when received, cause wireless-device operation in conformity with at least the first wireless-device parental control feature.

2. The apparatus of claim 1 wherein said selection detector is configured to detect selection of prohibition of operation of a wireless-device application.

3. The apparatus of claim 2 wherein detection of the selection of the prohibition further comprises detection of selection of times during which the prohibition is in effect.

4. The apparatus of claim 2 wherein detection of the prohibition further comprises detection of geographical areas beyond which the prohibition is in effect.

5. The apparatus of claim 4 wherein the wireless-device application comprises voice-service functionality.

6. The apparatus of claim 1 wherein said selection detector is configured to detect selection of wireless-device-camera operability.

7. The apparatus of claim 1 wherein said selection detector is configured to detect selection of wireless-device call-logging operability.

8. The apparatus of claim 1 wherein said selection detector is configured to detect selection of wireless-device, text-message collection operability.

9. The apparatus of claim 8 said wherein the wireless-device, text-message operability further comprises text-message compilation and network-return capability.

10. The apparatus of claim 1 wherein said selection detector is configured to detect selection of wireless-device call blocking functionality.

11. The apparatus of claim 1 wherein said selection detector is configured to detect selection of wireless-device call forwarding functionality.

12. The apparatus of claim 1 wherein said selection detector is configured to detect selection of location-dependent functionality.

13. The apparatus of claim 1 wherein said selection detector is configured to detect selection of an application download restriction.

14. The apparatus of claim 1 wherein said selection detector is configured to detect selection of an installed-file change restriction.

15. The apparatus of claim 1 wherein said selection detector and said control sign generator are network-positioned.

16. The apparatus of claim 1 wherein said selection detector and said control signal generator are wireless-device-positioned.

17. A method for facilitating effectuation of a wireless-device, parental-control feature, said method comprising:
detecting selection of at least a first wireless-device parental control feature; and
generating a wireless-device control signal of values that, when received, cause wireless-device operation in conformity with the at least the first wireless-device parental control feature.

18. An apparatus for facilitating effectuation of a parental control feature at a wireless device, said apparatus comprising:
a control signal detector configured to detect reception at the wireless device of a control signal of values representative of at least a first wireless-device parental control feature; and
a parental control feature implementer configured to initiate implementation of the at least the first wireless-device parental control feature identified in the control signal detected by said control signal detector.

19. The apparatus of claim 18 wherein the wireless device further comprises a first wireless-device application the first wireless-device parental control feature pertains to the first wireless-device application.

20. The apparatus of claim 19 wherein said parental control feature implementer is further configured to control the wireless-device application feature to cause the first wireless-device application to conform with the first wireless-device parental control feature.

21. The apparatus of claim 18 wherein the control signal detected by said control signal detector comprises a wireless-device-originated control signal.

22. A method for facilitating effectuation of a parental control feature at a wireless device, said method comprising:
detecting reception at the wireless device of a control signal of values representative of at least a first wireless-device parental control feature; and
initiating implementation of the at least the first wireless-device parental control feature identified in the control signal detected during said detecting.
